(19) United States
(12) Patent Application Publication
(10) Pub. No.: US 2007/0091137 A1
(43) Pub. Date: Apr. 26, 2007

(54) Printer calibration method

(75) Inventors: Matthew Grant Lopez, Escondido, CA (US); Gareth R. Kelly, San Diego, CA (US); Mark Alan Overton, Escondido, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 11/255,963

(22) Filed: Oct. 24, 2005

(51) Int. Cl. B41J 29/393

(52) U.S. Cl. 347/19

(57) ABSTRACT

A method of calibrating a printing apparatus comprising: providing a printing apparatus with a mobile printhead, the printhead being mobile along a scanning direction, the printhead comprising a plurality of nozzles; providing a media; printing a first pattern on the media while scanning the media with the printhead at a first scanning velocity; printing a second pattern on the media while scanning the media with the printhead at a second velocity, the absolute value of the second velocity differing from the absolute value of the first velocity; comparing the printed patterns to each other by optical means; setting the printhead scanning velocity for printing in relation to the velocity associated with the pattern having the best definition.

### FIELD OF THE INVENTION

The invention relates to the field of calibrating printing apparatuses, and more particularly printing apparatuses carrying a mobile printhead.

### BACKGROUND OF THE INVENTION

Printing apparatuses commonly operate by firing ink droplets onto a media, using for example thermal ink jet or piezo ink jet technology. As the requirements on image definition increase, the size of the droplets has reduced. At the same time, the requirements on printing speed are also increasing. These requirements should be fulfilled while maintaining reasonable printing costs. The firing of ink drops by the printing apparatus should be as fast and precise as possible. However, a common feature of this technology is that a drop fired onto a media is not necessarily landing on the media as a perfect round shape. In some cases, the drop fired result in a plurality of drops called the main drop and satellite or secondary drops. This feature is for example due to the printing speed, or for example to the hydraulics of the nozzle ejecting the ink.

### PRIOR ART

This feature has been identified and studied in the prior art. In EP1201432 for example, the printhead of a printing device may be tilted at an angle, whereby the influence of the angle on the drop shape is studied in order to optimize the shape of the fired drops. US20030132975 proposes compensating the occurrence of satellite drops by using a specific bi-directional printing mode. The object of the invention is to improve the shape of a drop when landing on a media.

### SUMMARY OF THE INVENTION

This object is achieved in a first aspect of the invention by a method of calibrating a printing apparatus comprising:
providing a printing apparatus with a mobile printhead, the printhead being mobile along a scanning direction, the printhead comprising a plurality of nozzles;
providing a media;
printing a first pattern on the media while scanning the media with the printhead at a first scanning velocity;
printing a second pattern on the media while scanning the media with the printhead at a second velocity, the absolute value of the second velocity differing from the absolute value of the first velocity;
comparing the printed patterns to each other by optical means;
setting the printhead scanning velocity for printing in relation to the velocity associated with the pattern having the best definition.

While printing on a media, the definition is dependent on a large number of variables including for example the velocity of the printhead, the angle of the printhead in relation to the media, the firing frequency of the nozzles, the actual shape of the nozzle, etc. . . . In addition, the behavior of these variables in not necessarily independent. For example, if a nozzle is fired on the media while respecting a specific space between firing a nozzle twice, if a relatively slow speed is used, a relatively low firing frequency will be used. For respecting the same specific space at a higher speed, the firing frequency will also need to be higher. It should be noted that a nozzle, due to its specific design, normally procures a definition dependent on its firing. Furthermore, when fixing a travel velocity for a print head, it should be noted that mechanical phenomena such as static friction may occur, which prevents a smooth travel of the printhead, meaning that the printhead does not have a constant speed but is submitted to accelerations in a direction or/an in the opposite direction during a printhead scan. The definition may also depend on the type of ink used. The invention provides a method which allows a user to optimize its printing definition without need to analyze such a complex system.

In its first aspect, the invention relates to providing a printing apparatus with a mobile printhead, the printhead being mobile along a scanning direction, the printhead comprising a plurality of nozzles. A printing apparatus may be one of different types of apparatuses including but not limited to one of the following: piezo ink jet printer, thermal ink jet printer, fax machine, multi function printer, photocopier, etc. . . . The printhead is mobile along a scanning direction. In an embodiment, the scanning direction is a straight line. In an embodiment, the printhead is located onto a mobile carriage. In an embodiment, the printhead is a disposable printhead. In an embodiment, the printhead is a permanent printhead. In an embodiment, the printhead is a permanent printhead comprising about 4000 nozzles. The print head comprises a plurality of nozzles. In an embodiment, the printhead comprises at least 200 nozzles. In an embodiment, the printhead comprises at least 400 nozzles. In an embodiment, the printhead comprises at least 600 nozzles. In an embodiment, the printhead comprises at least 1000 nozzles. In an embodiment, the nozzles form an array on the printhead. In an embodiment, the nozzles form an array along two perpendicular directions. In an embodiment, the nozzles form an array along two perpendicular directions, one of the directions of the array being parallel to the scanning direction. In an embodiment, the nozzles form an array along two perpendicular directions, one of the directions of the array being parallel to the scanning direction, whereby the array has a width of two nozzles along the scanning direction, the array extending along the direction perpendicular to the scanning direction.

According the invention, a media is provided. The media used is typically a sheet of paper, which may be a laminate, and may also be or comprise plastic resins or textile fibers, woven or non woven. The media is typically laminar, but may have a variety of shapes, for example packages such as bottles or boxes and the like. The media is typically flexible such as a sheet of paper but may also be rigid, such as card board or wood. The media may be provided in the form of a roll.

According to the invention, a first pattern is printed on the media while scanning the media with the printhead at a first scanning velocity. It should be noted that the printhead velocity of the print apparatus of the invention may be tuned by a control system of the printing apparatus of the invention. In an embodiment, the velocity is the average velocity of the printhead while scanning the media. Typically, scanning the media should be understood as moving the printhead in a straight line in one direction at a substantially homogeneous velocity from one end of the media to an opposite end of the media while printing a swath on the media.

According to the invention, a second pattern is printed on the media while scanning the media with the printhead at a second velocity, the absolute value of the second velocity differing from the absolute value of the first velocity. The velocity according to the invention is a vector, the vector having a norm and a direction. The absolute value of the velocity is not a vector but a number equal to the value of the velocity, the number having a strictly positive value independently from the direction of the velocity as a vector.

According to the invention, the printed patterns are compared to each other by optical means. In an embodiment, the printed patterns are compared to each other directly. In another embodiment, the printed patterns are compared to each other indirectly. By indirectly, it should be understood that each pattern may be directly compared with a reference pattern instead of comparing the printed patterns directly to each other.

According to the invention, the printhead scanning velocity for printing is set in relation to the velocity associated with the pattern having the best definition. In an embodiment, the printhead scanning velocity for printing is set at the first velocity. In another embodiment, the printhead scanning velocity for printing is set at the second velocity. The printhead velocity for printing is the actual printhead velocity which will be used for printing for normal use of the printing apparatus after realizing the calibration method.

The invention related to the definition. The definition may be understood as the sharpness of demarcation of outlines or limits of a mark printed on the media. The aim is indeed to reduce or ideally eliminated any blur which would not be desired. Typically, when printing a letter for example, the letter has some degree of “fuzziness” introduced by the imperfection of the shape of the drops landing onto the media while printing. In an embodiment, definition is measured by calculating the ratio between the width in the scanning direction of a printed pattern element and the ideal width in the scanning direction of the pattern element, which ratio will typically be larger than 1. The definition may also be calculated by comparing the width in the scanning direction of the same pattern printed at a first velocity and at a second velocity, whereby the best definition would correspond to the width which is most reduced.

In an embodiment of the invention according to its first aspect, the method further comprises:
print a third pattern on the media while scanning the media with the printhead at a third scanning velocity, the third velocity having the same absolute value than the first velocity, and the third velocity having a direction opposite to the direction of the first velocity;
print a fourth pattern on the media while scanning the media with the printhead at a fourth scanning velocity, the fourth velocity having the same absolute value than the second velocity, and the fourth velocity having a direction opposite to the direction of the second velocity.

This particular embodiment is realized using a printing apparatus allowing bi-directional printing, whereby the first velocity has a direction opposite to the third velocity, and whereby the second velocity has a direction opposite to the fourth velocity.

In an embodiment of the invention according to its first aspect, the method further comprises:
printing at least one further pattern on the media while scanning the media with the printhead at a further velocity, whereby the absolute value of the further velocity differs from the absolute value of the first velocity, and whereby the absolute value of the further velocity differs from the absolute value of the second velocity. This implies testing a third velocity during calibration. It should be noted that testing a higher number of velocities allows providing a higher number of data points, leading to a potential improvement in choosing the appropriate velocity for printing. In an embodiment, data points are used for extrapolating and/or interpolating an optimum velocity for printing.

In an embodiment of the invention according to its first aspect, a further plurality of patterns is printed, each pattern being printed at a respective scanning velocity, whereby the plurality of scanning velocities describes a range. In describing a range of velocities during calibration, the velocity for printing may be set with increased accuracy. In an embodiment, the range is centered at the nominal velocity for the printing apparatus. In an embodiment, the range comprises at least 5 velocities including the first and the second velocity. In an embodiment, the range comprises at least 10 velocities including the first and the second velocity. In an embodiment, the range comprises velocities separated by a fixed velocity differential. In a further embodiment, the velocity differential is fixed and is of 1 inch per second, meaning that the range would comprise velocities separated by 1 inch per second. In another embodiment, the velocity differential is fixed and is of 0.5 inch per second.

In an embodiment of the invention according to its first aspect, each pattern comprises a plurality of repeated pattern elements, each pattern element having a thickness along the scanning direction, the thickness along the scanning direction being of the order of a font thickness. In this embodiment, the method is more specifically aimed at improving the sharpness of printing characters. Each pattern element has a thickness of the order of a font thickness along the scanning direction. Indeed, the method aims in this embodiment at a correction of the drop shape in the scanning direction, in order to obtain a drop shape closer to an ideal drop shape. A typical font thickness is of the order of 1 mm. In an embodiment, a pattern element has a thickness along the scanning direction of at least 0.1 mm. In an embodiment, a pattern element has a thickness along the scanning direction of at least 0.2 mm. In an embodiment, a pattern element has a thickness along the scanning direction of at least 0.5 mm. In an embodiment, a pattern element has a thickness along the scanning direction of less than 2 mm. In an embodiment, a pattern element has a thickness along the scanning direction of less than 1.5 mm. In an embodiment, a pattern element has a thickness along the scanning direction of less than 1 mm. In an embodiment, the pattern element is printed along its thickness by firing the nozzles at a frequency which is dependent on the scanning velocity at which it is printed. Typically, the larger the scanning velocity, the higher the firing frequency. In an embodiment, the best definition is evaluated by comparing the thickness of the pattern elements in function of the scanning velocity at which they were printed. In an embodiment, the pattern comprises a plurality of repeated pattern elements, thus allowing for a plurality of measurements to take place, allowing for a statistical analysis of the data, thereby improving the final result of the method.

The method according to the invention may influence the layering of colors resulting for example in a more accurate resulting color, and/or may influence halftoning reproduction resulting for example in avoiding grain in a resulting image.

It should be understood that a printed pattern is normally different from the ideal pattern which was intended to be printed. In an embodiment, the first, second, further or extra patterns are ideally identical. In this embodiment, considering that the printing conditions are different when printing the patterns, each printed pattern will typically differ from any other pattern, even if the original ideal pattern was the same for all occurrences. Normally, the drops are—ideally—assumed to be round drops. Considering the effect which the invention aims at compensating, real drops will typically have an extent along the scanning axis larger than the ideal extend, meaning that the thickness of pattern elements along the scanning axis will spread compared to the ideal thickness, thereby leading to a definition worse than ideally expected.

In an embodiment of the invention according to its first aspect, the best definition is evaluated in relation to the shape of the drops fired by the nozzles. Each drop fired by the nozzle may take a variety of shape when landing onto the media. It is this shape of a drop when landed onto the media which is considered when evaluating the definition. A drop fired may result in a plurality of drops when landing, or in a “deformed” drop when landing. In an embodiment, one or more drop fired by the nozzles includes a main drop and one or more satellite drops.

In an embodiment of the invention according to its first aspect, the optical means comprise a scanner. The optical means may also be a human eye, with optional help of a reading grid which may be printed or pre-printed onto the media. A human eye may provide a direct read or a read using a microscope. The optical means may also be a spectrometer. Typically, the optical means provides an output, which in an embodiment is an electronic output. The output is typically in the shape of data, whereby the data may be analyzed, for example using statistics, in order to choose the velocity for printing corresponding to the best definition. It should be noted that the “best resolution” according to the invention may not be the absolute best resolution achievable by the printer. In an embodiment, the scanner is mobile along the scanning direction. In an embodiment, the printhead and the scanner are both mounted on a carriage, the carriage being mobile along the scanning direction.

This object is achieved in a second aspect by a method of calibrating a printing apparatus comprising:
providing a printing apparatus with a mobile printhead, the printhead being mobile along a scanning direction, the printhead comprising a plurality of nozzles;
providing a media;
printing a first pattern on the media while scanning the media with the printhead at a first scanning velocity;
printing a second pattern on the media while scanning the media with the printhead at a second velocity, the absolute value of the second velocity differing from the absolute value of the first velocity;
comparing the printed pattern to each other by optical means;
setting the printhead scanning velocity for printing in relation to the velocity associated with the pattern having the best definition when printing a text;
   whereby each pattern comprises a plurality of repeated pattern elements, each pattern element having a thickness along the scanning direction, the thickness along the scanning direction being of the order of a font thickness, and
   whereby the best definition is evaluated by comparing the thickness of the pattern elements in function of the scanning velocity at which they were printed.

In an embodiment of the second aspect of the invention, each pattern element is a segment having a direction perpendicular to the scanning direction.

In an embodiment of the second aspect of the invention, a further plurality of patterns are printed, each pattern being printed at a respective scanning velocity, whereby the plurality of scanning velocities describes a range.

In an embodiment of the second aspect of the invention, the method is executed after changing the printhead of the printing apparatus. It should be understood that the effect that the invention aims at compensating is typically dependent on the specific printhead which is being used. In an embodiment, the printhead is a disposable printhead, and the printing apparatus is provided with a calibration procedure which is executed automatically directly after replacing a printhead whereby the method according to the invention is part of the calibration procedure.

This object is achieved in a third aspect by a method of calibrating a printing apparatus comprising:
providing a printing apparatus with a mobile printhead, the printhead being mobile along a scanning direction, the printhead comprising a plurality of nozzles;
providing a media;
printing a first pattern on the media while scanning the media with the printhead at a first scanning velocity;
printing a second pattern on the media while scanning the media with the printhead at a second velocity, the absolute value of the second velocity differing from the absolute value of the first velocity;
print a third pattern on the media while scanning the media with the printhead at a third scanning velocity, the third velocity having the same absolute value than the first velocity, and the third velocity having a direction opposite to the direction of the first velocity;
print a fourth pattern on the media while scanning the media with the printhead at a fourth scanning velocity, the fourth velocity having the same absolute value than the second velocity, and the fourth velocity having a direction opposite to the direction of the second velocity;
comparing the printed pattern to each other by optical means;
setting the printhead scanning velocity for printing in relation to the velocity associated with the pattern having the best definition when printing a text;
   whereby each pattern comprises a plurality of repeated pattern elements, each pattern element having a thickness along the scanning direction, the pattern element being printed along its thickness by firing the nozzles at a frequency which is dependent on the scanning velocity at which it is printed. This particular aspect specifically takes the bi-directionality of a printing apparatus into account. By bi-directional, it should be understood that the printhead may print while moving both back and forth along the scanning direction.

In an embodiment of the third aspect of the invention, the method is executed at least once after changing the printhead of the printing apparatus. The method may be part of a calibration procedure. Such a calibration procedure may be automatically triggered by insertion of a printhead in the printing system. In an embodiment, realization of the method according to any aspect of the invention is triggered by a user, for example if the user is not fully satisfied by the aspect of a print out.

In an embodiment of the third aspect of the invention, the thickness corresponds to a font thickness.

In an embodiment of the third aspect of the invention, the optical means is a sensor, the sensor being comprised in the printing apparatus.

In an embodiment of the third aspect of the invention, each pattern element is a segment having a direction perpendicular to the scanning direction.

### BRIEF DESCRIPTION OF THE DRAWINGS

FIG. 1 is a representation of a drop.

FIG. 2 is a representation of a drop after landing on a printing media.

FIG. 3 is a representation of a drop after landing on a printing media.

FIG. 4 is a representation of a drop after landing on a printing media.

FIG. 5 is a representation of a media printed according to a method of the invention.

### DETAILED DESCRIPTION

The method was realized using a multifunction printing apparatus comprising a permanent print head comprising six groups of nozzles, each group comprising about 600 nozzles, each group printing in a different color, so that six inks are being used. Each nozzle ejects ink drops of about 4 pl (picoliters) in volume, at a typical frequency of at least about 12 KHz and of up to about 24 Khz. Nominal printhead velocity was about 20 ips.

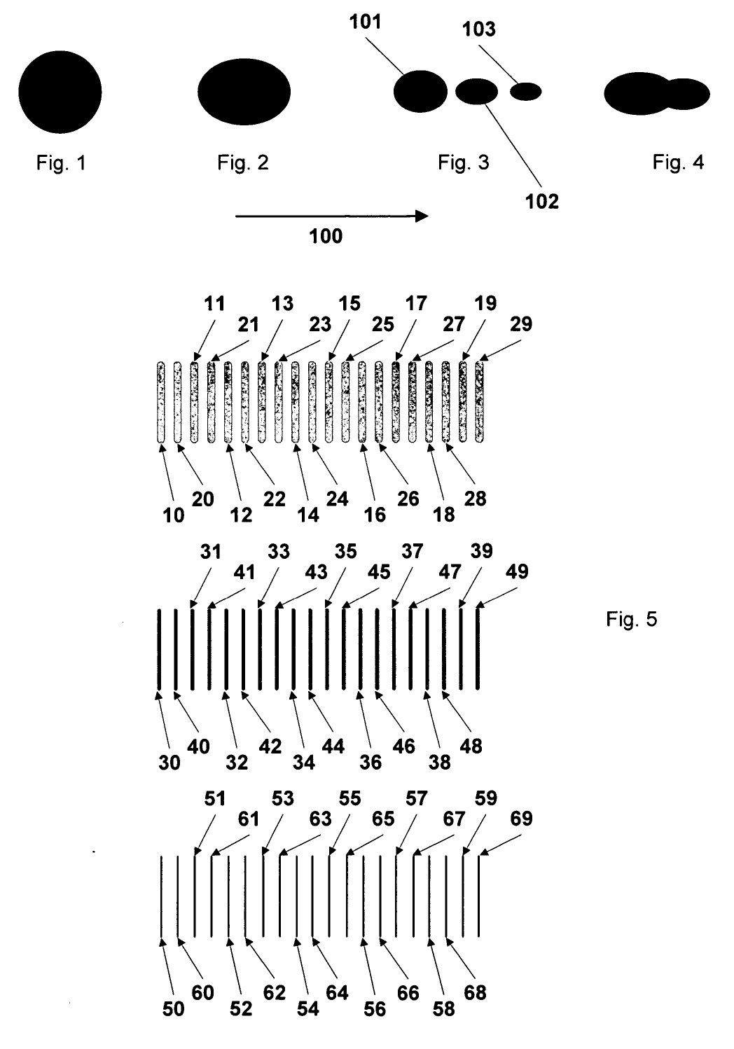

In FIG. 1, an ink drop is represented. The drop in FIG. 1 is a perfect drop in that its shape is perfectly round. Ideally, a print out would be formed of a large plurality of such drops. In the reality however, when landing on a media drops take a variety of shapes. In FIG. 2, a possible shape for a real drop is represented, whereby the drop was fired by a nozzle located on a printhead traveling along the direction represented by arrow 100. In FIG. 2, the drop takes an ovoid or elliptical shape due to a number of factors including the velocity of the printhead. In FIG. 3, another possible shape is represented, whereby the drop divided into 3 drops, being the main drop 101, and the satellite drops 102 and 103. In FIG. 4, a further possible shape taken by a drop when landing onto the media is represented, whereby the drop divided in two drops which partially overlapped. In FIGS. 2 to 4, the representation is typical of the type of drop obtained when firing a nozzle which is located on a printhead traveling in the direction of the arrow 100.

On FIG. 5, a print-out of a media is represented which was printed using an embodiment of a method of the invention. FIG. 5 comprises 6 patterns. The first pattern comprises pattern elements 10 to 19, the second pattern comprises pattern elements 20 to 29, the third pattern comprises pattern elements 30 to 39, the fourth pattern comprises pattern elements 40 to 49, the fifth pattern comprises pattern elements 50 to 59, and the sixth pattern comprises pattern elements 60 to 69. I should be noted that each pattern is represented with 10 pattern elements, even though more or less pattern elements may be used. Typically, more pattern elements would be used. Each of the six patterns is printed using a different printhead velocity. The first, third and fifth patterns are printed with a velocity in the direction of arrow 100. The second, fourth and sixth patterns are printed with a velocity in the direction opposed to the direction of arrow 100. The first and second patterns are printed at a velocity having the same first absolute value. The third and fourth patterns are printed at a velocity having the same second absolute value. The fifth and sixth patterns are printed at a velocity having the same third absolute value. The second absolute value is the nominal value for printing velocity for the printer used which is 20 ips. The first absolute value is the nominal value for printing velocity for the printer used plus 10%, in other words 22 ips. The third absolute value is the nominal value for printing velocity for the printer used minus 10%, in other words 18 ips. Each of the 60 pattern elements 10 to 69 should ideally look the same when printed. As exemplified on FIG. 5, the appearance of the printed pattern elements is however dependent of the speed used, which may be due to a number of factors including the shape of the drops when landing on the media. It should be noted that in reality, the difference between patterns would not be as noticeable as represented on FIG. 5, where the difference was amplified for reasons of clarity. Ideally, a pattern element should have the following dimensions: 9/16″ height and, 10/600″ width, the width being along the direction of arrow 100. Each of the patterns is scanned; the results of the scan being used to built a histogram. An analysis of the histogram including the calculation of the average value of the thickness of each pattern element for each pattern lead to the conclusion that the patterns having the best definition or best corresponding to the ideal pattern were the fifth and sixth patterns. In this particular embodiment, no difference was found between printing in one direction or in the opposite direction, meaning that the scan results of the first pattern were found equal to the scan results of the second, and that the scan results of the third pattern were found equal to the scan results of the fourth and that the scan results of the fifth pattern were found equal to the scan results of the sixth.

In an embodiment, the method is realized for a range of velocities comprising 5 absolute values being the nominal absolute velocity, nominal +/−10% and nominal +−20%, being for example the following absolute values: 16, 18, 20, 22 and 24 ips.

In an embodiment, the method is realized for a range of velocities comprising 11 absolute values being the nominal absolute velocity, nominal +/−5%, nominal +/−10%, nominal +/−15%, nominal +/−20% and nominal +−25%, being for example the following absolute values: 15, 16, 17, 18, 19, 20, 21, 22, 23, 24 and 25 ips.

From the foregoing it will be appreciated that the method provided by the invention represents a significant advance in the art. Although specific embodiments of the invention have been described and illustrated, the invention is not to be so limited. Thus, the above described embodiments should be regarded as illustrative rather than descriptive, and it should be appreciated that variations may be made in those embodiments by workers skilled in the art without departing from the scope of the invention as described in the following claims.

1. A method of calibrating a printing apparatus comprising:
providing a printing apparatus with a mobile printhead, the printhead being mobile along a scanning direction, the printhead comprising a plurality of nozzles;
providing a media;
printing a first pattern on the media while scanning the media with the printhead at a first scanning velocity;
printing a second pattern on the media while scanning the media with the printhead at a second velocity, the absolute value of the second velocity differing from the absolute value of the first velocity;
comparing the printed patterns to each other by optical means;
setting the printhead scanning velocity for printing in relation to the velocity associated with the pattern having the best definition.

2. A method according to claim 1, whereby the method further comprises:
print a third pattern on the media while scanning the media with the printhead at a third scanning velocity, the third velocity having the same absolute value than the first velocity, and the third velocity having a direction opposite to the direction of the first velocity;
print a fourth pattern on the media while scanning the media with the printhead at a fourth scanning velocity, the fourth velocity having the same absolute value than the second velocity, and the fourth velocity having a direction opposite to the direction of the second velocity;

3. A method according to claim 1, whereby the method further comprises:
printing at least one further pattern on the media while scanning the media with the printhead at a further velocity, whereby the absolute value of the further velocity differs from the absolute value of the first velocity, and whereby the absolute value of the further velocity differs from the absolute value of the second velocity.

4. A method according to claim 1, whereby a further plurality of patterns are printed, each pattern being printed at a respective scanning velocity, whereby the plurality of scanning velocities describes a range.

5. A method according to claim 1, whereby each pattern comprises a plurality of repeated pattern elements, each pattern element having a thickness along the scanning direction, the thickness along the scanning direction being of the order of a font thickness.

6. A method according to claim 5, whereby the pattern element is printed along its thickness by firing the nozzles at a frequency which is dependent on the scanning velocity at which it is printed.

7. A method according to claim 6, whereby the best definition is evaluated by comparing the thickness of the pattern elements in function of the scanning velocity at which they were printed.

8. A method according to claim 1, whereby the best definition is evaluated in relation to the shape of the drops fired by the nozzles.

9. A method according to claim 8, whereby one or more drop fired by the nozzles includes a main drop and one or more satellite drops.

10. A method according to claim 1, whereby the optical means comprise a scanner.

11. A method according to claim 10, whereby the scanner is a part of the printing apparatus, the scanner being mobile along the scanning direction.

12. A method of calibrating a printing apparatus comprising:
providing a printing apparatus with a mobile printhead, the printhead being mobile along a scanning direction, the printhead comprising a plurality of nozzles;
providing a media;
printing a first pattern on the media while scanning the media with the printhead at a first scanning velocity;
printing a second pattern on the media while scanning the media with the printhead at a second velocity, the absolute value of the second velocity differing from the absolute value of the first velocity;
comparing the printed pattern to each other by optical means;
setting the printhead scanning velocity for printing in relation to the velocity associated with the pattern having the best definition when printing a text;
whereby each pattern comprises a plurality of repeated pattern elements, each pattern element having a thickness along the scanning direction, the thickness along the scanning direction being of the order of a font thickness, and
whereby the best definition is evaluated by comparing the thickness of the pattern elements in function of the scanning velocity at which they were printed.

13. A method according to claim 12, whereby each pattern element is a segment having a direction perpendicular to the scanning direction.

14. A method according to claim 12, whereby a further plurality of patterns are printed, each pattern being printed at a respective scanning velocity, whereby the plurality of scanning velocities describes a range.

15. A method according to claim 12, whereby the method is executed after changing the printhead of the printing apparatus.

16. A method of calibrating a printing apparatus comprising:
providing a printing apparatus with a mobile printhead, the printhead being mobile along a scanning direction, the printhead comprising a plurality of nozzles;
providing a media;
printing a first pattern on the media while scanning the media with the printhead at a first scanning velocity;
printing a second pattern on the media while scanning the media with the printhead at a second velocity, the absolute value of the second velocity differing from the absolute value of the first velocity;
print a third pattern on the media while scanning the media with the printhead at a third scanning velocity, the third velocity having the same absolute value than the first velocity, and the third velocity having a direction opposite to the direction of the first velocity;
print a fourth pattern on the media while scanning the media with the printhead at a fourth scanning velocity, the fourth velocity having the same absolute value than the second velocity, and the fourth velocity having a direction opposite to the direction of the second velocity;
comparing the printed pattern to each other by optical means;
setting the printhead scanning velocity for printing in relation to the velocity associated with the pattern having the best definition when printing a text;
whereby each pattern comprises a plurality of repeated pattern elements, each pattern element having a thickness along the scanning direction, the pattern element being printed along its thickness by firing the nozzles at a frequency which is dependent on the scanning velocity at which it is printed.

17. A method according to claim 16, whereby the method is executed at least once after changing the printhead of the printing apparatus.

18. A method according to claim 16, whereby the thickness corresponds to a font thickness.

19. A method according to claim 16, whereby the optical means is a sensor, the sensor being comprised in the printing apparatus.

20. A method according to claim 16, whereby each pattern element is a segment having a direction perpendicular to the scanning direction.
